(19) United States
(12) Patent Application Publication
(10) Pub. No.: US 2026/0117114 A1
(43) Pub. Date: Apr. 30, 2026

(54) Method of Improving Performance of Relative Permeability Modifiers

(71) Applicant: Baker Hughes Oilfield Operations LLC, Houston, TX (US)

(72) Inventors: Naima Bestaoui-Spurr, The Woodlands, TX (US); Akshaya Singh, Boalsburg, PA (US)

(73) Assignee: Baker Hughes Oilfield Operations LLC, Houston, TX (US)

(21) Appl. No.: 18/931,702

(22) Filed: Oct. 30, 2024

(51) Int. Cl. C09K 8/508; C09K 8/512; E21B 43/16

(52) U.S. Cl. CPC C09K 8/5083; C09K 8/512; E21B 43/16; C09K 2208/10

(57) ABSTRACT

Relative permeability modifier (RPM) macromolecules when combined with nanoparticles are effective in modifying the permeability of subterranean reservoirs at temperatures in excess of 250° F.

### FIELD

The disclosure relates to methods and compositions for modifying the permeability of subterranean formations. In particular, the disclosure relates to methods and compositions for selectively reducing the production of water from subterranean formations; the composition having a relative permeability modifier (RPM) macromolecule and one or more types of nanofillers.

### BACKGROUND

The production of hydrocarbons from subterranean reservoirs is often complicated by the presence of water within the well. The source of the water may be formation water as well as injected water used for reservoir maintenance. In other instances, heterogeneities encountered in reservoir rocks can cause water channeling through higher permeability streaks/hairline fractures. Further, water coming into the production wellbore often occurs during hydrocarbon extraction. Produced water is also generally considered to be an inevitable consequence of water injection when water flooding is used to develop a hydrocarbon reservoir or when the field drive mechanism involves strong aquifer support.

Water production typically reduces the amount of oil and/or gas that may be ultimately recovered from a well since the water takes the place of other fluids that may flow or be lifted from the well. High water rates cause a reduction in well productivity and increase in operating expenditures. Furthermore, operating costs associated with disposal of produced water in an environmentally safe manner typically increase with the volume of produced water, thus increasing the threshold amount of hydrocarbons that must be produced in order to continue economical production of the well. Along with adversely affecting the economic return in hydrocarbon production from the well, the life of the well is also often reduced by the presence of water. Further, produced water can cause scaling issues in susceptible wells, induce fines migration or sandface failure, increase corrosion of tubulars, and sometimes even kill wells by hydrostatic loading.

While water production is an inevitable consequence of oil production, it is often desirable to defer its onset, or at least its rise, for as long as possible during hydrocarbon production. Varying degrees of success in the control of water and water production have been reported by the use of Relative Permeability Modifiers (RPMs), which are water-soluble, hydrophilic polymer systems which, when hydrated, produce long polymer chains that loosely occupy pore spaces in the rock. Being strongly hydrophilic, RPMs attract water and repel oil and, as a net result, exert a “drag force” on water flow in the pores with a minimal effect on oil flow.

U.S. Pat. No. 6,228,812 B1 discloses RPM macromolecules of copolymers having hydrophilic and anchoring monomeric units for reducing water production. U.S. Pat. No. 6,465,397 B1 recites a crosslinked polymer having a balance of intramolecular and intermolecular crosslinking sites as a suitable RPM macromolecule. While the use of such RPM macromolecules reduce costs by reducing water permeability without affecting oil permeability, they are not certain to impart long-lasting effectiveness nor exhibit a high degree of water flow resistance relative to oil flow, especially in high temperature wells as well as wells characterized by produced water of higher salinity. Alternative RPM systems, especially for use in higher temperature and/or saline wells, are therefore needed.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof herein.

### SUMMARY

In an embodiment, a method for reducing or eliminating the production of water in an oil or gas well is provided by introducing into the well an aqueous fluid comprising a relative permeability modifier (RPM) macromolecule capable of impeding the production of water; and nanoparticles.

In another embodiment, the performance of a relative permeability (RPM) macromolecule during production of hydrocarbons from a well may be enhanced by combining one or more nanoparticles with one or more relative permeability macromolecules (RPMs).

In an embodiment, the nanoparticles may be metal or metalloid oxides or hydroxides, metal or metalloid carbides, metal or metalloid nitrides, alkali metals, alkaline earth metals, a transition metal, a lanthanide, actinide, post-transition metals, alumina and boehmite, fullerenes, graphenes, nanographites, nanotubes, nanodots, nanodiamonds, nanoclays, polysilsesquioxanes, carbon nanotubes, inorganic nanotubes, metallated nanotubes or a combination thereof, nano-layered silicates, nanoclays, as well as exfoliated nanoclays.

In another embodiment, the relative permeability modifier (RPM) macromolecule may be a copolymer of a hydrophilic monomeric unit and a first anchoring monomeric unit, the first anchoring unit being based on at least one of N-vinylformamide, N,N-diallylacetamide or a mixture thereof.

In another embodiment, the relative permeability modifier may be a crosslinked copolymer of:
(a) 1 to 90 wt. % of monomeric units of the structural formula CH₂═C(R¹)—C(O)N(R²)₂ (I) where R¹ and R² independently represent a hydrogen, methyl, ethyl, propyl or butyl moiety;
(b) 1 to 75 wt. % of monomeric units of the structural formula CH₂═C(R³)(R⁴) (II) where R³ is hydrogen or methyl and R⁴ is a sulfo, sulfophenyl, sulfoalkyl, sulfoalkyl amido group or a phosphonic acid group or a sodium, potassium, ammonium, calcium, magnesium, partial salts or mixed salts thereof; and
(c) 1 to 50 wt. % of monomeric units of the structural formula CH₂═C(R⁵)N(R⁶)C(O)R⁷ wherein R⁵, R⁶ and R⁷ are independently methyl, ethyl and hydrogen and optionally R⁶ and R⁷ form a cyclic amide.

### DETAILED DESCRIPTION

Characteristics and advantages of the present disclosure and additional features and benefits will be readily apparent to those skilled in the art upon consideration of the following detailed description of exemplary embodiments.

As used herein and throughout various portions, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

All ranges disclosed herein are inclusive of the endpoints. A numerical range having a lower endpoint and an upper endpoint shall further encompass any number and any range falling within the lower endpoint and the upper endpoint. For example, every range of values (in the form “from a to b” or “from about a to about b” or “from about a to b,” “from approximately a to b,” “between about a and about b,” and any similar expressions, where “a” and “b” represent numerical values of degree or measurement is to be understood to set forth every number and range encompassed within the broader range of values and inclusive of the endpoints.

The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

A fluid useful in reducing or eliminating the production of water in a well may contain nanoparticles in addition to a relative permeability modifier (RPM) macromolecule. While the downhole temperature in the well subjected to treatment is typically at least 125° F., the fluid has particular applicability in the treatment of wells having a temperature in excess of 225° F., as well as in excess of 250° F. or 275° F. and in some cases at least 300° F. and in other cases as high as 350° F. and in other cases as high as 450° F. The fluid also has particular applicability in the treatment of reservoirs of high salinity. In an embodiment, high salinity shall refer to in excess over 15,000 total dissolved solids (TDS) and often in excess of 100,000 TDS.

The aqueous fluid may be utilized in well treatment methods to selectively reduce the permeability of a subterranean formation to water, while at the same time leaving the permeability of the formation to oil virtually unchanged. Furthermore, fluids containing the RPM macromolecules with nanoparticles, when introduced into a formation, tend to exhibit a high resistance to removal from water bearing areas of the formation over time. In a preferred embodiment, the post-treatment resistance factor for water (permeability to water before versus permeability to water after treatment) is greater than or equal to 5.0, preferably in excess of 9 or more. Furthermore, the disclosed compositions, when introduced into a formation, tend to exhibit a high resistance to removal from water bearing areas of the formation over time.

The nanoparticles of the fluid have a number average particle size which is typically less than 2.000 nm in diameter, typically less than 1.000 nm and preferably to about 500 nm in diameter, more preferably from about 1 to about 250 nm, often from about 1 to about 100 nm as well from about 5 to about 20 nm in diameter. [Generally, as used herein, “particle size” refers to the number average particle size along the longest particle dimension, and can be determined using particle size measurement methods known in the art, such as laser light scattering (static or dynamic light scattering), or direct determination methods such as scanning electron microscopy (SEM) or transmission electron microscopy (TEM)]. The nanoparticles are typically distributed in the fluid containing the RPM macromolecules. Typically, the nanoparticles referenced herein are spherical.

The concentration of nanoparticles in a fluid pumped into the reservoir may be 0.1% (8.34 pounds per thousand gallons (“pptg”) by weight based on the total weight of the fluid or above. In other cases, the concentration of nanoparticles in the aqueous fluid may be greater than 0.5% (about 41.7 pptg) by weight based on the total weight of the aqueous fluid. In an embodiment, the concentration of nanoparticles can range from about 2% to about 20% by weight (about 167 pptg to about 1670 pptg). Typically, the amount in weight of the nanoparticles to the RPM macromolecules in the aqueous fluid is less than 10 wt. %, preferably less than 5 wt. %, and more typically less than 3 wt. % and in some cases from 0.1 to 2 wt. %.

The fluid containing the combination of RPM macromolecules and nanoparticle(s) is aqueous and in some cases forms a gel. Typically, the nanoparticles do not form a reaction product with the RPM. In an embodiment, the nanoparticles remain dispersed in a gel containing the RPM.

Suitable nanoparticles include inorganic nanoparticles such as a metal or metalloid oxide or hydroxide like silica, alumina, titania, silicic acid, aluminum oxides, aluminum hydroxides, aluminum hydroxyoxides, aluminosilicates, zirconium oxides, zirconium hydroxides, zirconium hydroxyoxides, tungsten oxide or iron oxide as well as a metal or metalloid carbide like tungsten carbide, silicon carbide and boron carbide and metal or metalloid nitrides like titanium nitride, boron nitride and silicon nitride or a combination thereof. Metal nanoparticles include alkali metals, alkaline earth metals, inner transition metals (a lanthanide or actinide), a transition metal, or a post-transition metal. Examples of such metals include magnesium, aluminum, iron, tin, titanium, platinum, palladium, cobalt, nickel, vanadium, chromium, manganese, zirconium, ruthenium, hafnium, tantalum, tungsten, rhenium, osmium, alloys thereof as well as barium or strontium titanate or a combination thereof. Preferred nanoparticles include alumina, boehmite and zirconia.

Other suitable nanoparticles include fullerenes, nanotubes, graphenes like nanographite, nanodots, nanorods, nanodiamonds, polysilsesquioxanes, antimony oxide, vanadium oxide and magnesium oxide and mixtures thereof.

Fullerenes include cage-like hollow polyhedral allotropic carbon forms possessing a polyhedral structure and include those having from about 20 to about 100 carbon atoms.

Nanographites may be represented as clusters of plate-like sheets of graphite having a stacked structure of one or more layers of graphite of plate-like two-dimensional structures of fused hexagonal rings

Suitable graphenes including nanographene and graphene fibers (graphene particles having an average largest dimension of greater than 1 μm, a second dimension of less than 1 μm, and an aspect ratio of greater than 10, where the graphene particles form an interbonded chain). The graphene and nanographene fibers are effectively two-dimensional particles having more than one layer of fused hexagonal rings. Typically, the graphene nanoparticles may be prepared by exfoliation of a graphite source such as nanographite, graphene or nanographene, graphite and intercalated graphite. Exemplary exfoliation methods include fluorination, acid intercalation as well as acid intercalation followed by high temperature treatment Exfoliation of the nanographite provides a nanographene having fewer layers than non-exfoliated nanographite. Exfoliation of nanographite may provide the nanographene as a single sheet only one molecule thick, or as a layered stack of sheets. In an embodiment, the exfoliated nanographene may have fewer than 50 single sheet layers and in another embodiment fewer than 5 single sheet layers.

Suitable nanotubes include carbon nanotubes, inorganic nanotubes (e.g., boron nitride nanotubes), metallated nanotubes or a combination thereof. Suitable nanotubes include single walled nanotubes (SWNTs) or multi-walled nanotubes (MWNTs).

Suitable polysilsesquioxanes (also referred to as polyorganosilsesquioxanes or polyhedral oligomeric silsesquioxanes (POSS) derivatives) are polyorganosilicon oxide compounds of general formula RSiO_{1.5} (where R is an organic group such as methyl) having defined closed or open cage structures (closo or nido structures). Polysilsesquioxanes, including POSS structures may be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

In addition, the nanoparticles may further be nano-layered silicates or nanofibers and nanoclays (hydrated or anhydrous silicate, plate-like minerals with a layered structure). Exemplary nanoclays include aluminosilicate clays like kaolins (including vermiculite), hallyosite, bentonite, smectites (including montmorillonite), saponite, beidellite, nontrite, hectorite, alllophane and illite as well as titanium sulfate and zirconium sulfate. The nanoclays may be exfoliated to separate individual sheets, or non-exfoliated. Other nanosized mineral fillers of similar structure which may be used include talc, micas including muscovite, phlogopite or phengite. Platelets of the nanoclay typically have a thickness of about 3 to about 1000 Angstroms, a size in the planar direction ranging from about 0.01 μm to 100 μm and a specific surface area in from about 90 to about 800 m²/g. The aspect ratio (length versus thickness) is generally in the order of about 10 to about 10,000.

Other suitable nanoparticles include layered phosphate materials such as alpha-zirconium phosphate and titanium phosphates, synthetic layered alumino silicates as well as layered hydroxides and layered perovskites and nanofibers such as metal oxides (e.g., nano silica, nano titania, nano antimony oxides, etc.). In an embodiment, the nanolayers can be a few nanometers thick to sub nanometer thickness

Further, properties of the nanoparticles may be enhanced by the use of third materials (such as metal oxides having a perovskite structure) which will provide ferroelectric, dielectric, pyroelectric and piezoelectric behavior to the nanoparticles under an applied field.

Further, the nanoparticles may be derivatized to include a variety of different functional groups such as, for example, carboxy (e.g., carboxylic acid and anhydride groups like maleic anhydride), epoxy, ether, ketone, amine, hydroxy, alkoxy, alkyl, aryl, aralkyl, alkaryl, lactone as well as functionalized polymeric or oligomeric groups. In an embodiment, the nanoparticles include a combination of derivatized nanoparticles and underivatized nanoparticles. Derivatization of the nanoparticles typically improves the wettability of the nanoparticles with the polymer chains of the RPM macromolecule.

The nanoparticles may further be derivatized to include one or more functional groups that are hydrophilic, hydrophobic, oxophilic, lipophilic, or oleophilic. In an embodiment, such functional groups may include (i) organosilicon materials, (ii) fluorinated organic acids or a reactive derivative; (iii) linear or branched alkyl organic acids or a reactive derivative, (iv) substituted alkyl organic acids or a reactive derivative, (v) aryl or substituted aryl organic acids or a reactive derivative as well as (vi) mixtures thereof. In an embodiment, the nanoparticles include hydrophilic groups. By increasing the hydrophilicity of the nanoparticles, the fluid is capable of increasing uptake of water which renders a more efficient system to block or slow down production of water in tie well.

In an embodiment, the nanoparticles may be derivatized with an organic acid having a long chain alkyl, aryl or fluoro group. Suitable organic acids include carboxylic acids, sulfonic acids, phosphoric acids, phosphonic acids and phosphinic acids.

Exemplary carboxylic acids include those of the formula R—COOH where R is a linear or branched C₉-C₂₄, preferably C₁₂-C₂₁ hydrocarbon group or a hydroxylated derivative thereof or a C₆-C₂₀ aryl, alkylaryl or arylalkyl group. Suitable carboxylic acids include behenic acid, palmitic acid, etc. In an embodiment, the organic acid of the hydrophobic and/or oleophobic surface modifying agent has two or more carboxylic acid moieties and preferably wherein the number average molecular weight of the organic acid is between from about 80 g/mol to about 2,000 g/mol.

Suitable reactive derivatives of organic acids as referenced herein include acid chlorides such as those of the formula R′(C═O)Cl, esters such as those of the formula R′—COOR″ and corresponding acid anhydrides. In an embodiment R′ and R″ may be a C₁-C₈ hydrocarbon group or R as defined above.

In an embodiment, the nanoparticles may be derivatized with an organophosphoric acid, organophosphonic acid or organophosphinic acid or a sulfonic acid or a derivative thereof. The organo groups of the anchor may be monomeric or polymeric. In another embodiment, the organic acid of the derivatized nanoparticles may be a phosphoric acid, phosphonic acid, phosphinic acid or sulfonic acid having 1 to about 30 acid groups. In an embodiment, the number average molecular weight of the phosphoric acid, phosphonic acid, phosphinic acid or sulfonic acid is between about 100 g/mol to about 5,000 g/mol.

Examples of monomeric phosphoric acid and derivatives have the structure (RO)ₓ—P(O)—(OR′)_{y} wherein x is 1-2, y is 1-2 and x+y=3; R preferably is a radical having a total of 1-30, preferably 2-20, more preferably 6-18 carbons; R′ is H, a metal such as an alkali metal, for example, sodium or potassium or lower alkyl having 1 to 4 carbons, such as methyl or ethyl. Preferably, a portion of R′ is H. The organic component of the phosphoric acid (R) can be a saturated or unsaturated aliphatic group or can be an aryl or aryl-substituted moiety. At least one of the organo groups can contain terminal or omega functional groups as described below.

Examples of monomeric phosphonic acid or derivatives include compounds or mixtures of compounds having the formula:

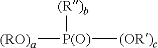

wherein a is 0-1, b is 1, c is 1-2 and a+b+c is 3; R and R″ preferably are each independently a radical having a total of 1-30, preferably 2-20, more preferably 6-18 carbons; R′ is H, a metal, such as an alkali metal, for example, sodium or potassium or lower alkyl having 1-4 carbons such as methyl or ethyl. Preferably at least a portion of R′ is H. The organic component of the phosphonic acid (R and R″) can be a saturated or unsaturated aliphatic group or an aryl or aryl-substituted moiety. At least one of the organo groups can contain terminal or omega functional groups as described below.

Examples of monomeric phosphinic acid or derivatives are compounds or mixtures of compounds having the formula:

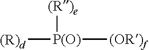

wherein d is 0-2, e is 0-2, f is 1 and d+e+f is 3; R and R″ preferably are each independently radicals having a total of 1-30, preferably 2-20 carbons atoms, more preferably 6-18 carbons; R′ is H, a metal, such as an alkali metal, for example, sodium or potassium or lower alkyl having 1-4 carbons, such as methyl or ethyl. Preferably a portion of R′ is H. The organic component of the phosphinic acid (R, R″) can be a saturated or unsaturated aliphatic group or be an aryl or aryl-substituted moiety. Examples of organo groups which may comprise R and R″ include long and short chain aliphatic hydrocarbons, aromatic hydrocarbons and substituted aliphatic hydrocarbons and substituted aromatic hydrocarbons.

At least one of the organo groups can further contain one or more terminal or omega functional groups which are hydrophobic. Examples of terminal or omega functional groups include carboxyl such as carboxylic acid, hydroxyl, amino, imino, amido, thio and phosphonic acid, cyano, sulfonate, carbonate and mixed substituents.

Representative of organophosphorus acids or derivatives are amino trismethylene phosphonic acid, aminobenzylphosphonic acid, 3-amino propyl phosphonic acid, O-aminophenyl phosphonic acid, 4-methoxyphenyl phosphonic acid, aminophenylphosphonic acid, aminophosphonobutyric acid, aminopropylphosphonic acid, benzhydrylphosphonic acid, benzylphosphonic acid, butylphosphonic acid, carboxyethylphosphonic acid, diphenylphosphinic acid, dodecylphosphonic acid, ethylidenediphosphonic acid, heptadecylphosphonic acid, methylbenzylphosphonic acid, naphthylmethylphosphonic acid, octadecylphosphonic acid, octylphosphonic acid, pentylphosphonic acid, phenylphosphinic acid, phenylphosphonic acid, styrene phosphonic acid, and dodecyl bis-1,12-phosphonic acid.

In addition to monomeric organophosphorus acid and derivatives, oligomeric or polymeric organophosphorus acid derivatives resulting from self-condensation of the respective monomeric acids may be used.

The hydrophobic and/or oleophobic modified nanoparticles may contain fluorine. In an embodiment, the hydrophobic and/or oleophobic nanoparticles contain a fluorine containing moiety having a number average molecular weight of less than 2000. Preferred fluorinated materials are esters of perfluorinated alcohols such as the alcohols of the structure F—(CFY—CF₂)ₘ—CH₂—CH₂—OH where Y is F or CₙF₂ₙ₊₁; m is 4 to 20 and n is 1 to 6. Further preferred fluorinated materials are those of the structure R_{f}—(CH₂)ₚ—X where R_{f} is a perfluoroalkylene ether group or a perfluorinated alkyl group such as those described above, p is an integer of from 0 to 18, preferably 0 to 4, and X is a polar group, such as a carboxyl group, preferably a carboxylic ester group containing from 1 to 50, preferably from 2 to 20 carbon atoms in the alkyl group that is associated with the ester linkage.

In an embodiment, the nanoparticles may be derivatized with a hydrophobic and/or oleophobic moiety of the formula R_{f}-(D)ₚ-Z where Z is the organic acid moiety, D is —CH₂ or an (OE)ₚ group, E is a C₁-C₃ alkylene group, R_{f} is a perfluorinated alkyl group or contains a perfluorinated alkylene ether group, particularly a perfluorinated alkyl group or perfluorinated alkylene ether group referenced herein, and p is 2 to 4.

In an embodiment, the nanoparticles may be derivatized with the moiety R_{f}—(CH₂)ₚ— where R_{f} is a perfluorinated alkyl group or contains a perfluorinated alkylene ether group and p is 2 to 4, preferably 2. In a preferred embodiment, the nanoparticles may be derivatized with a moiety of the formula R_{f}—(CH₂)ₚ—Z where Z, the situs of the attachment to the nanoparticle surface is H, F or an acid derivative, and the hydrophobic and/or oleophobic portion (bonded to the surface of the nanoparticle) is the R_{f}—(CH₂)ₚ— moiety where R_{f} is a perfluorinated alkyl group or contains a perfluorinated alkylene ether group referenced above and p is 2 to 4, preferably 2.

In another embodiment, the nanoparticles may be derivatized with a moiety of the formula R_{f}—(CH₂)ₚ—Z, wherein Z is:

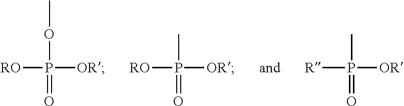

as referenced above and in a preferred embodiment where R and R″ independently may be a hydrocarbon or substituted hydrocarbon radical having up to 200, such as 1 to 30 and 6 to 20 carbons, R and R″ can also include the perfluoroalkyl groups mentioned above, and R′ is H, a metal such as potassium or sodium or an amine or an aliphatic radical, for example, alkyl including substituted alkyl having 1 to 50 carbons, preferably lower alkyl having 1 to 4 carbons such as methyl or ethyl, or aryl including substituted aryl having 6 to 50 carbons.

Further examples of perfluorinated groups for the fluorine containing moiety are those of the structure:

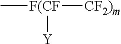

where Y is F or CₙF₂ₙ₊₁; m is 4 to 20 and n is 1 to 6.

A preferred oligomeric or perfluoroalkylene ether group is where R and/or R″ is a group of the structure:

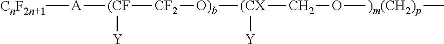

where A is an oxygen atom or a chemical unit such as —CF₂; n is 1 to 20, preferably 1 to 6; Y is H, F, CₙH₂ₙ₊₁ or CₙF₂ₙ₊₁; X is H or F; b is at least 1, preferably 2 to 10, m is 0 to 50, and p is 1 to 20.

In an embodiment, the nanoparticles are derivatized with a moiety of the formula CF₃(CₙF₂ₙ)CH₂CH₂PO₃H₂ where n is between 3 and 5 or CF₃(CF₂)ₓO(CF₂CF₂)_{y}—CH₂CH₂—PO₃H₂ where x is from 0 to 7, y is from 1 to 20 and x+y is less than or equal to 27.

In another embodiment, the organosilicon used to derivatized nanoparticles may be a silane, polysiloxane or a polysilazane. In an embodiment, the organo-silicon containing compound may be an organo(poly)siloxane or organo(poly)silazane of molecular weight of at least 400, usually between 1000 and 5,000,000.

Examples of organosilicon materials are alkoxysilanes as well as acidic compounds having a branched or unbranched alkyl group.

Suitable organosilicon containing materials further include those of the formula R¹₄₋ₓSiAₓ or (R¹₃Si)_{y}B as well as organo(poly)siloxanes and organo(poly)silazanes containing units of the formula:

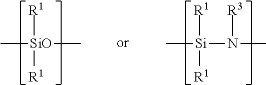

where R¹ may be the same or different and is a hydrocarbon radical containing from 1 to 100, such as 1 to 20 carbon atoms and 1 to 12, preferably 1 to 6 carbon atoms and R³ may be hydrogen or a hydrocarbon or substituted hydrocarbon having 1 to 12, preferably 1 to 6 carbon atoms. In addition, R¹ may be a substituted, hydrocarbon radical such as halo, particularly a fluoro-substituted hydrocarbon radical. The organo(poly)siloxane may further contain additional units of the formula: R⁵₂SiO₂ where R⁵ is a halogen such as a chloro or fluoro substituent.

The substituent A in R¹₄₋ₓSiAₓ may be hydrogen, a halogen such as chloride, OH, OR² or

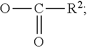

B in the formula (R¹₃Si)_{y}B may be NR³_{3-y}, R² a hydrocarbon or substituted hydrocarbon radical containing from 1 to 12, typically 1 to 4 carbon atoms. R³ is hydrogen or has the same meaning as R¹, x is 1, 2 or 3 and y is 1 or 2.

Preferably, R¹ is a fluoro-substituted hydrocarbon radical. Preferred are such fluoro-substituted hydrocarbons as those of the structure:

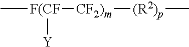

where Y is F or CₙF₂ₙ₊₁; m is 4 to 20 and n is 1 to 6; R² is alkyl containing from 1 to 4 carbon atoms and p is 0 to 18. Also, fluoro-substituted hydrocarbons may be of the structure:

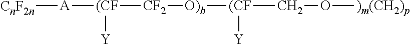

where A is an oxygen atom or a chemical unit; n is 1 to 6, Y is F or CₙF₂ₙ; b is at least 1, such as 2 to 10; m is 0 to 6 and p is 0 to 18.

Preferred organosilicon materials include halogenated siloxanes, halogenated alkoxysiloxanes such as perfluoroalkoxysiloxane (PFOSi), alkoxy halogenated alkoxysilanes, such as alkoxy-perfluoroalkoxysilane; alkoxyacetylacetonate halogenated polysiloxanes, such as alkoxyacetylacetonate-perfluoroalkoxysiloxane, alkoxy-alkylsilylhalides; polyalkylsiloxanes, such as polydimethylsiloxanes, and alkoxyacetylacetonate-polyalkylsiloxanes, such as alkoxyacetylacetonate (acac) polydimethylsiloxanes. Exemplary modifying agents with which the nanoparticles are derivatized include tantalum halide-perfluoroalkoxysiloxane, such as TaCl₅:PFOSi; tantalum alkoxy-perfluoroalkoxysilane; tantalum alkoxyacetylacetonate-perfluoroalkoxysiloxane, like Ta(EtO)₄acac:PFOSi; tantalum alkoxy-alkylsilylhalide; tantalum halide-polyalkylsiloxane, like TaCl₅:PDMS; niobium alkoxide-perfluoroalkoxysiloxane, such as Nb(EtO)₅:PFOSi and Ta(EtO)₅:PFOSi; titanium alkoxide-perfluoroalkoxysiloxane, like Ti(n-BuO)₄:PFOSi; zirconium alkoxide-perfluoroalkoxysiloxane; lanthanum alkoxide-perfluoroalkoxysilane, like La(iPrO)₃:PFOSi; tungsten chloride-perfluoroalkoxysiloxane, like WCl₆:PFOSi; tantalum alkoxide-polyalkylsiloxane, like Ta(EtO)₅:PDMS; and tantalum alkoxyacetylacetonate-polyalkylsiloxane, like Ta(EtO)₄acac:PDMS.

In an exemplary embodiment, the nanoparticles are derivatized by amination to include amine groups, where amination may be accomplished by nitration followed by reduction, or by nucleophilic substitution of a leaving group by an amine, substituted amine, or protected amine, followed by deprotection, as necessary. In another embodiment, the nanoparticles are derivatized by oxidative methods to produce an epoxy, hydroxy group or glycol group using a peroxide, or by cleavage of a double bond by for example a metal mediated oxidation such as a permanganate oxidation to form ketone, aldehyde, or carboxylic acid functional groups.

Where the functional groups are alkyl, aryl, aralkyl, alkaryl, functionalized polymeric or oligomeric groups, or a combination of these groups, the functional groups may be attached through intermediate functional groups (e.g., carboxy, amino) or directly to the derivatized nanoparticles by a carbon-carbon bond without intervening heteroatoms, to provide greater thermal and/or chemical stability to the derivatized nanoparticles by a carbon-oxygen bond (where the nanoparticles contain an oxygen-containing functional group such as hydroxy or carboxylic acid); or by a carbon-nitrogen bond (where the nanoparticles contain a nitrogen-containing functional group such as amine or amide). In an embodiment, the nanoparticles may be derivatized by metal mediated reaction with a C6-30 aryl or C7-30 aralkyl halide (F, Cl, Br, I) in a carbon-carbon bond forming step.

In another embodiment, nanoparticles such as fullerene, nanodiamond, or nanographene may be directly metallated by reaction with e.g., an alkali metal such as lithium, sodium, or potassium, followed by reaction with a C1-30 alkyl or C7-30 alkaryl compound with a leaving group such as a halide (Cl, Br, I) or other leaving group (e.g., tosylate, mesylate, etc.) in a carbon-carbon bond forming step. The aryl or aralkyl halide, or the alkyl or alkaryl compound, may be substituted with a functional group such as hydroxy, carboxy, ether, or the like. Exemplary groups include, for example, hydroxy groups, carboxylic acid groups, alkyl groups such as methyl, ethyl, propyl, butyl, pentyl, hexyl, octyl, dodecyl and octadecyl; aryl groups including phenyl and hydroxyphenyl; alkaryl groups such as benzyl groups attached via the aryl portion, such as in a 4-methylphenyl, 4-hydroxymethylphenyl, or 4-(2-hydroxyethyl)phenyl (also referred to as a phenethylalcohol) group or aralkyl groups attached at the benzylic (alkyl) position such as found in a phenylmethyl or 4-hydroxyphenyl methyl group, at the 2-position in a phenethyl or 4-hydroxyphenethyl group. In an exemplary embodiment, the derivatized nanoparticles are nanographene substituted with a benzyl, 4-hydroxybenzyl, phenethyl, 4-hydroxyphenethyl, 4-hydroxymethylphenyl or 4-(2-hydroxyethyl)phenyl.

In another embodiment, the nanoparticles may be further derivatized by grafting certain polymer chains to the functional groups. For example, polymer chains such as acrylic chains having carboxylic acid functional groups, hydroxy functional groups, and/or amine functional groups; polyamines such as polyethyleneamine or polyethyleneimine; and poly(alkylene glycols) such as poly(ethylene glycol) and poly(propylene glycol), may be included by reaction with functional groups.

The nanoparticles when pumped into the well in the aqueous fluid may carry a charge that results in an electric potential in the dispersion, otherwise known as Zeta potential. The Zeta potential of the dispersion can be varied in order to control the viscosity of the fluid pumped into the well. The viscosity of the fluid may be controlled by increasing or decreasing the Zeta potential.

Most often the RPM has the ability to remain hydrated in formation waters while simultaneously having an affinity to adsorb onto the solid formation material.

Suitable RPM macromolecules may be ionic or non-ionic and include crosslinked RPM macromolecules, anionic RPMs, crosslinked RPM microgels, anionic RPM microgels, and anionic RPM microgels which are crosslinked. RPM macromolecules may optionally be deformable.

Other suitable RPM macromolecules are those which have a K-value, measured according to standard test methods (e.g., ISO 1628-2 (DIN 53726)), in the range from about 200 to about 1,000. Typically, the RPM macromolecules will have a K-value in the range from about 200 to about 500, and more typically a K-value in the range from about 250 to about 300.

The RPM macromolecules have a weight average molecular weight ranging from about 10,000 g/mol to about 50,000,000 g/mol, preferably from about 50,000 g/mol to about 5,000,000 g/mol, and more preferably from about 100,000 g/mol to about 2,000,000 g/mol. The RPM macromolecules may be used at concentrations in the aqueous fluid such that the fluid has a viscosity from about 1 cP (0.001 Pa-s) to about 20 cP (0.020 Pa-s), and more preferably from about 1 cP (0.001 Pa-s) to about 5 cP (0.005 Pa-s), as measured by standard techniques.

Suitable RPM macromolecules include soft microgels which may be crosslinked and have a weight average molecular weight of from about 10⁴ to 10⁸ g/mol. In some instances, the microgel is crosslinked in an amount from about 0.25 to about 2.5 weight percent, based on the weight of the microgel. Such microgels may further have a size of from about 0.001 microns in diameter to about 100 microns in diameter.

The fluid contains the RPM macromolecule and the nanoparticle(s) in a synergistic amount such that the level the RPM macromolecule impedes, reduces or eliminates water permeability without affecting oil permeability is enhanced relative to the use of the same RPM (or nanoparticle(s)) when used separately. In an embodiment, the weight ratio of RPM macromolecule to nanoparticles in the fluid is from about 200:1 to about 1:200. Typically, the concentration of nanoparticles in the fluid is from about 0.1 wt. % to about 10 wt. %, preferably from about 0.1 to 5 wt. % and most preferably from about 0.25 to about 3 wt. percent.

Suitable RPM macromolecules include those described in U.S. Pat. Nos. 5,735,349; 6,169,058; 6,465,397; and 6,228,812, herein incorporated by reference. Optionally, the RPM macromolecule can include one or more organosilicon compounds. In such instances, the RPM may have a grafting site for the organosilicon compound(s).

Such co-polymers include those having a hydrophilic monomeric unit and an anchoring unit to selectively reduce the permeability of a subterranean formation to water by a factor of about 10 or more, while at the same time leaving the permeability of the formation to oil virtually unchanged. As used herein, the term “anchoring unit” refers to a component that will preferentially bind, by either physical or chemical processes, to subterranean formation material and which therefore tends to retain the polymer to the formation material. Anchoring groups are typically selected to prevent a polymer from washing out of the formation due to fluid flow. Primary anchoring sites for the monomeric anchoring units are typically clay and feldspar surfaces existing in formation pores, channels and pore throats. Useful anchoring monomeric units include those having carboxylate, quaternary nitrogen or functional groups capable of hydrolyzing to form amine-based anchoring groups on the polymer. Examples include amide-containing monomeric units.

Examples of monomeric units of the polymer forming the anchoring unit include, but are not limited to, vinyl acrylamide comonomers including, but not limited to, acrylamide, N-vinyl acetamide, N-vinyl formamide, diallylacetamide, N,N-diallylacetamide, N-methylacetamide, N,N-diallyl acetamide, N-vinyl-N-methyl acetamide, N,N-dimethyl acetamide, N-vinyl-2-pyrrolidone, N-vinyl formamide (VF), and N-ethenyl-N-alkyl acetamide, as well as mixtures of two or more of such comonomers. Ionic monomers may be either anionic or cationic. In a preferred embodiment, the RPM macromolecules include those copolymers, homopolymers, or terpolymers comprised of at least one of N-vinylformamide, N-methylacetamide and/or N,N-diallylacetamide which may also be used with sodium acrylate.

As well as at least one monomeric anchoring unit, an optional secondary anchoring unit may also be used. Optional second anchoring monomeric units may include at least one of dimethyldiallylammonium chloride, ammonium or alkali metal salts of acrylic acid, (such as sodium salts), vinyl phosphonate or vinyl phosphinate, or vinyl phosphate or a mixture thereof.

The hydrophilic monomeric unit may be based on acrylamide, methacrylamide, alkali, alkaline salts of acrylic acid, acrylamidomethylpropane sulfonic acid (“AMPS”) as well as ammonium or alkali salts thereof, maleic acid, itaconic acid, styrene sulfonic acid, and vinyl sulfonic acid (or its ammonium or alkali metal salts). Examples of suitable cationic monomers include, but are not limited to, dimethyldiallyl ammonium chloride and quaternary ammonium salt derivatives from acrylamide or acrylic acid such as acrylamidoethyltrimethyl ammonium chloride.

In one embodiment, one or more hydrophilic monomeric units are typically employed and are based on AMPS (such as at least one of ammonium or alkali metal salt of AMPS, including sodium and/or potassium salts of AMPS), acrylic acid, an acrylic salt (such as sodium acrylate, N-vinyl pyrrolidone, ammonium or alkali metal salts of styrene sulfonic acid, etc.), or a mixture thereof. It may be desirable to employ ammonium or alkali metal salts of AMPS for added stability, with or without one or more other hydrophilic monomers, in those cases where aqueous treatment and/or formation fluids contain high concentrations of divalent ions, such as Ca⁺², Mg⁺², and the like.

In an embodiment, the amount of monomeric anchoring unit comprising the RPM macromolecule may be from 2 to about 30% by weight and the hydrophilic monomer from about 2 to about 15% by weight. In an embodiment, the copolymer may have a molecular weight of from about 100,000 to about 20 MM.

Preferred RPMs may further include homopolymers or copolymers which include the following monomeric units: acrylic acid, (meth)acrylic acid, dimethyldiallylammonium chloride as well as acrylamidoethyltrimethylammonium chloride, methacrylamidoethyltrimethylammonium chloride, acrylamidomethylpropanesulfonic acid (AMPS), N-vinyl pyrolidone, N-vinyl formamide, N-vinyl acetamide, N-vinylmethylacetamide, acrylamido ethyltrimethylammonium chloride, maleic acid, itaconic acid, styrene sulfonic acid, vinylsulfonic acid and vinylphosphonic acid and sulfonate monomers, i.e., those monomers containing SO₃ pendant or functional groups and salts thereof, such as those derived with sodium or potassium, or quaternary ammonium salts. Other suitable monomeric units include dimethyldiallyl ammonium sulfate, methacrylamido propyl trimethyl ammonium bromide, and methacrylmaido propyl trimethyl ammonium bromide.

In a more preferred embodiment, the RPM may be a copolymer having at least one of N-vinylformamide, N-methylacetamide and/or N,N-diallylacetamide or a mixture thereof as anchoring groups in combination with at least one of the referenced hydrophilic monomers, such as AMPS. The copolymer further may also include a second anchoring monomeric unit based on at least one of dimethyldiallyl ammonium chloride, acrylic acid (such as ammonium or alkali metal salts of acrylic acid) or a mixture thereof. Other optional anchoring groups, such as sodium acrylate, may also be present.

The RPM macromolecule containing compositions can also optionally include one or more additives for enhancing the anchoring capabilities of the RPM macromolecule to the formation substrate. Such additives include organosilane compounds, such as aminopropyltriethoxysilanes, or phosphonates, phosphinates, phosphates, polyphosphonates, polyphosphinates, polyphosphates, phosphinocarboxylic acids and their polymers, or mixtures thereof.

In an embodiment, the RPM macromolecule may be a copolymer of an acrylamide (especially an N-substituted α, β-unsaturated carboxylic amide) and a sulfonated or phosphonated vinyl comonomer crosslinked with a nonionic crosslinking monomer. In a preferred embodiment, the RPM macromolecule may be a crosslinked product of at least one nonionic vinylamide monomer and at least one ethylenically unsaturated sulfo- or phospho-containing monomer. Suitable vinylamide monomers include those of the formula CH₂═C(R¹)—C(O)N(R²)₂ (I) where R¹ and R² independently represent a hydrogen, methyl, ethyl, propyl or butyl moiety. In an embodiment, the vinylamide monomer may be acrylamide, methacrylamide, N-methylmethacrylamide, N-alkyl (C₁-C₄) methacrylamide, N,N-dialkyl (C₁-C₄) methacrylamide, N-alkyl (C₂-C₄) acrylamide, N,N-dialkyl (C₁-C₄) acrylamide and mixtures thereof.

Suitable ethylenically unsaturated sulfo- or phospho-containing monomers include those of the formula CH₂═C(R³)(R⁴) (II) where R³ is hydrogen or methyl and R⁴ is a sulfo, sulfophenyl, sulfoalkyl, sulfoalkyl amido (collectively “sulfo groups”) or phosphonic acid (—PO₃²⁻) (phosphono) group including sodium, potassium, ammonium, calcium, magnesium and partial salts or mixed salts. In an embodiment, the R⁴ alkylene units may contain C₂-C₁₀ groups or alkyl benzyl groups containing C₇ to C₁₆ carbon atoms, as well as mixtures thereof. The monomers of (I) and (II) may be crosslinked with a copolymerizable crosslinker. Preferred comonomers of (2) are the acrylamido alkyl C₂-C₁₀ alkylene, preferably C₂-C₆ alkylene, more preferably C₄-alkylene sulfonate.

In an embodiment, the RPM may be a crosslinked, water-soluble anionic copolymer which forms a non-gelled homogeneous aqueous fluid comprising from about 1% to 90%, preferably 20% to 75%, more preferably 30% to 65%, by weight of comonomer units of (I), from about 1% to 75% by weight, preferably from 10% to 60% by weight, more preferably from about 20% to 50% by weight of monomers of (II) and from about 0.01% by weight to 2% by weight of a copolymerizable crosslinking agent.

Suitable crosslinking monomers include multifunctional acrylamides and methacrylates containing unsaturation at preferably 2 (or more) site. In one embodiment, the multifunctional crosslinking monomer may be selected from monomeric polyesters of acrylic or methacrylic acids and polyhydric alcohols, and monomeric polyalkenyl polyethers of polyhydric alcohols containing from 2 to about 5 polymerizable alkenyl ether groups per polyether molecule. Another exemplary crosslinking monomer is a monomeric polyester of an acrylic or methacrylic acid and a polyhydric alcohol containing from 2 to about 6 polymerizable α,β-unsaturated acrylic groups per polyester molecule. Other copolymerizable crosslinking monomers include divinyl ether, ethylene glycol dimethacrylate, methlenebisacrylamide, allylpentaerythritol, trimethylol propane triacylate, trimethylyol propane trimethacrylate, diethylene glycol diacrylate, diethylene glycol dimethacrylate, trimethylene glycol diacrylate, butylene glycol diacrylate, methylene-bis-acrylamide, pentamethylene glycol diacrylate, octylene glycol diacrylate, glyceryl diacrylate, glyceryl Tri acrylate, neopentyl glycol diacrylate and the tetraacrylate ester of pentaerythritol

In an embodiment, the copolymer may also contain comonomers (III) of vinylacylamides of the structure CH₂═C(R⁵)N(R⁶)C(O)R⁷ wherein R⁵, R⁶ and R⁷ are independently methyl, ethyl and hydrogen and optionally R⁶ and R⁷ form a cyclic amide. When present, such comonomers may be present in an amount from 1 to 50%, more typically from about 2 to 40% and most preferably from about 5 to 30% by weight. In a preferred embodiment, the vinylacylamides are N-vinyl acetamide, N-vinyl-N-methyl acetamide, N,N-dimethyl acetamide, N-vinyl 2-pyrrolidone, N-vinyl formamide and N-ethenyl-N-alkyl acetamide and mixtures thereof.

In an embodiment, preferred comonomer of (I) include those wherein R¹ is hydrogen or an alkyl group of 1 to 4 carbon atoms and each of R² are hydrogen (such as N-t-butyl acrylamide, N-cyclohexyl acrylamide, and those alkyl amides wherein the alkyl group is from 8 to 32 carbon atoms. Such acrylic amides include N-alkylol amides of alpha, beta-olefinically unsaturated carboxylic acids and having N-alkyl groups from 4 to 10 carbon atoms, such as N-methylol acrylamide, N-propylol acrylamide, N-methylol methacrylamide, N-methylol maleimide, N-methylol maleamic acid esters, and N-methylol-p-vinyl benzamide. Representative monomers of (II) include sulfonated and phosphono vinyl monomers such as vinyl sulfonate acid and salt (e.g., alpha-olefin sulfonate), 2-acrylamido-alkyl (C₂-C₁₀) sulfonic acid, including salts, vinyl sulfonic acid, salts of vinyl sulfonic acid, vinyl benzene sulfonic acids, salts of vinyl benzene sulfonic acid, allyl sulfonic acid, salts of allyl sulfonic acid, meth allyl sulfonic acid, salts of meth allyl sulfonic acid, 3-methacrylamideo-2-hydroxypropyl sulfonic acid, salts of 3-methacyrlamideo-2-hydroxypropyl sulfonic acid and vinyl phosphonic acid and combinations thereof wherein acid salts are those of a cation selected form sodium, potassium, ammonium, calcium and magnesium. The most preferred structure of (2) is AMPS.

Further, such copolymers may have randomly incorporated carboxylic acid comonomers, such as the olefinically unsaturated carboxylic acids containing at least one carbon to carbon olefinic double bond and at least one carboxyl group that is readily converted to a carboxylic acid and containing an olefinic double bond reactive in polymerization because of the presence of the monomer molecule either in the alpha-beta position with respect to a carboxyl group, —C═C—COOH; or as part of a terminal methylene grouping, H₂C═C— or a cyclic anhydride. Olefinically unsaturated acids include the acrylic acids, e.g., acrylic acid, alpha-cyano acrylic acid, beta methyl acrylic acid (crotonic acid), alpha-phenyl acrylic acid, beta-acryloxy propionic acid, cinnamic acid, p-chloro cinnamic acid, 1-carboxy-4-phenyl butadiene-1,3 itaconic acid, citraconic acid, mesaconic acid, glutaconic acid, aconitic acid, maleic acid, fumaric acid and tricarboxy ethylene, maleic anhydride. In an embodiment, the amount of such optional comonomers in the crosslinked copolymer may be from 10 to 30% by weight.

The preferred optional carboxylic acid comonomers are the monoolefinic acrylic acids of the structure H₂C—C(R₂)COOH wherein R₂ is selected from hydrogen, halogen and the cyanogen groups, monovalent alkyl radicals, e.g., methyl, ethyl, monovalent aryl radicals, monovalent aryl substituted alkyl radicals, monovalent alkyl substituted aryl radicals and monovalent cyclolaliphatic radicals.

The copolymers can optionally be phosphonated by a copolymerizable phosphonic acid-containing monomer, such as vinyl phosphonic acid, methylvinyl phosphonic acid, polyvinylphosphonic acid and their salts or by reaction of the copolymer with a phosphonating agent such as phosphorus trichloride.

The copolymers may also have incorporated optionally a minor amount from 0.5 to 20% of a cationic functional group such as a quaternary ammonium group. Preferred cationic comonomers are di-C₁-C₄ alkyl diallyl ammonium chloride, such as diallyl dimethyl ammonium chloride (DADMAC).

In an embodiment, the crosslinked polymer as RPM may contain from 20% to 75% by weight of comonomer units of (I), 20 to 50% by weight of comonomer units of (II), from 0.01 to 2% by weight of a copolymerized ethylenic unsaturated multifunctional comonomer, from 2 to 40% by weight of a monomer (III) and from 0.5 to 40% by weight of a comonomer of H₂C═C(H)(PO₃²⁻) 2X⁴ or H₂C═C(H)(PO₃²⁻) X²⁺ wherein X is hydrogen or a monovalent or divalent cation, or mixture of cations selected from the group consisting of sodium, potassium, magnesium, calcium or ammonium.

The above-described fluids can be used to treat oil and gas producing wells, as well as subterranean, hydrocarbon-producing formations. Such fluids may be prepared in advance and stored until use, or they can be prepared “on demand” at the work site. In accordance with this latter aspect, for example, the RPM macromolecule and nanoparticles may be mixed to the desired concentration at the wellsite. This allows for the overall composition of the fluid to be adjusted as necessary, depending upon the specific problems or characteristics of the individual wellsite.

The fluid can be introduced into a hydrocarbon producing well or hydrocarbon producing subterranean formation using any means, such as by pumping through a wellbore, or injecting through an injector or producer well into a subterranean formation. The pumping or injecting can be through coiled tubing, conventional pipes, or other delivery systems. Typically, the aqueous fluid is pumped at a sufficient volume and pressure such that it contacts the downhole, subterranean formation for a time sufficient to act. For example, the compositions can be allowed to contact the formation for about 12 hours, by being “shut in”. Times of contact suitable for use with the compositions described herein will vary depending upon the individual composition, the needs of the well, and the desired result of the contact, but contact times can include ranges from about 2 hours to about 12 hours, from about 4 hours to about 10 hours, and from about 6 hours to about 8 hours. Specific examples of contact times suitable in association with the working compositions include about 2 hours, about 4 hours, about 6 hours, about 8 hours, about 10 hours, about 12 hours, and ranges between any two of these values. These treatments can also be pumped with carbon dioxide or nitrogen gases, either during the pumping of the treatment or after the treatment, as a flush. Pumping with the gases allows better coverage of the treatment interval, particularly as a means to increase contact with the formation, reduce the treatment volume and hence, the treatment cost.

Embodiment 1. A method for reducing or eliminating the production of water in an oil or gas well by introducing into the well an aqueous fluid comprising:
(a) a relative permeability modifier (RPM) macromolecule capable of impeding the production of water; and
(b) nanoparticles.

Embodiment 2. The method of embodiment 1, wherein the nanoparticles have a number average particle less than 200) nm in diameter.

Embodiment 3. The method of embodiment 2, wherein the nanoparticles have a number average particle less than 1,000 nm in diameter.

Embodiment 4. The method of embodiment 3, wherein the nanoparticles have a number average particle size from about 5 about 500 nm in diameter.

Embodiment 5. The method of any of embodiments 1 to 4, wherein the nanoparticles are selected from the group consisting of metal or metalloid oxides or hydroxides, metal or metalloid carbides, metal or metalloid nitrides, alkali metals, alkaline earth metals, a transition metal, a lanthanide, actinide, post-transition metals, alumina and boehmite.

Embodiment 6. The method of 3embodiment 5, wherein the nanoparticles are selected from the group consisting of silica, alumina, titania, silicic acid, aluminum oxides, aluminum hydroxides, magnesium oxide, zirconium oxides, zirconium hydroxides, zirconium hydroxyoxides, tungsten oxide, iron oxide, antimony oxide, vanadium oxide, tungsten carbide, silicon carbide, boron carbide, titanium nitride, boron nitride, silicon nitride, magnesium, aluminum, iron, tin, titanium, platinum, palladium, cobalt, nickel, vanadium, chromium, manganese, zirconium, ruthenium, hafnium, tantalum, tungsten, rhenium, osmium, barium titanate, strontium titanate or a combination thereof.

Embodiment 7. The method of any of embodiments 1 to 4, wherein the nanoparticles are selected from the group consisting of fullerenes, graphenes, nanographites, nanotubes, nanodots, nanodiamonds, nanoclays, polysilsesquioxanes and combinations thereof.

Embodiment 8. The method of embodiment 7, wherein the nanoparticles are nanographene and graphene fibers having an average largest dimension of greater than 1 μm, a second dimension of less than 1 μm, and an aspect ratio of greater than 10, where the graphene particles form an interbonded chain.

Embodiment 9. The method of embodiment 7, wherein the nanoparticles are nanographene and graphene fibers are two-dimensional particles having more than one layer of fused hexagonal rings.

Embodiment 10. The method of embodiment 9, wherein the nanoparticles are graphene nanoparticles prepared by exfoliation of a graphite source.

Embodiment 11. The method of any of embodiments 1 to 4, wherein the nanoparticles are carbon nanotubes, inorganic nanotubes, metallated nanotubes or a combination thereof.

Embodiment 12. The method of any of embodiments 1 to 4, wherein the nanoparticles are nano-layered silicates or nanoclays.

Embodiment 13. The method of embodiment 12, wherein the nanoparticles are aluminosilicate clays, hallyosite, bentonite, smectites, saponite, beidellite, nontrite, hectorite, allophane, illite, titanium sulfate and zirconium sulfate.

Embodiment 14. The method of any of embodiments 1 to 4, wherein the nanoparticles are exfoliated nanoclays.

Embodiment 15. The method of any of embodiments 1 to 14, wherein the nanoparticles are derivatized with a functional group selected from the group consisting of carboxy, epoxy, ether, ketone, amine, hydroxy, alkoxy, alkyl, aryl, aralkyl, alkaryl, lactone, organosilicon materials, fluorinated organic acids or a reactive derivative; linear or branched alkyl organic acids or a reactive derivative, substituted alkyl organic acids or a reactive derivative, aryl or substituted aryl organic acids or a reactive derivative and mixtures thereof.

Embodiment 16. The method of any of embodiments 1 to 14, wherein the nanoparticles are derivatized with one or more functional groups that are hydrophilic, hydrophobic, oxophilic, lipophilic, or oleophilic.

Embodiment 17. The method of embodiment 16, wherein the functional groups include (i) organosilicon materials, (ii) fluorinated organic acids or a reactive derivative; (iii) linear or branched alkyl organic acids or a reactive derivative, (iv) substituted alkyl organic acids or a reactive derivative, (v) aryl or substituted aryl organic acids or a reactive derivative as well as (vi) mixtures thereof.

Embodiment 18. The method of embodiment 16, wherein the nanoparticles are derivatized with a moiety selected from the group consisting of organophosphoric acids, organophosphonics acid and organophosphinic acids or a derivative thereof.

Embodiment 19. The method of any of embodiments 1 to 18, wherein the relative permeability modifier (RPM) macromolecule is a copolymer comprising a hydrophilic monomeric unit and a first anchoring monomeric unit, wherein said first anchoring unit is based on at least one of N-vinylformamide, N,N-diallylacetamide or a mixture thereof.

Embodiment 20. The method of embodiment 19, wherein the first anchoring monomeric unit is based on N-vinylformamide.

Embodiment 21. The method of embodiment 19 or 20, wherein the relative permeability modifier (RPM) macromolecule has a second anchoring monomeric unit based on at least one of dimethyldiallyl ammonium chloride, ammonium or alkali metal salts of acrylic acid or a mixture thereof.

Embodiment 22. The method of any of embodiments 18 to 21, wherein the hydrophilic monomeric unit is based on at least one of ammonium or alkali metal salt of acrylamidomethylpropanesulfonic acid, acrylic acid, acrylate salt or a mixture thereof.

Embodiment 23. The method of any of embodiment 1 to 18, wherein the relative permeability modifier (RPM) macromolecule is a crosslinked polymer based on N-substituted α, β-unsaturated carboxylic amide and a sulfonated or phosphonated vinyl monomer.

Embodiment 24. The method of embodiment 23, wherein the relative permeability modifier is a crosslinked copolymer of:
(a) 1 to 90 wt. % of monomeric units of the structural formula CH₂═C(R¹)—C(O)N(R²)₂ (I) where R¹ and R² independently represent a hydrogen, methyl, ethyl, propyl or butyl moiety;
(b) 1 to 75 wt. % of monomeric units of the structural formula CH₂═C(R³)(R⁴) (II) where R³ is hydrogen or methyl and R⁴ is a sulfo, sulfophenyl, sulfoalkyl, sulfoalkyl amido group or a phosphonic acid group or a sodium, potassium, ammonium, calcium, magnesium, partial salts or mixed salts thereof; and
(c) 1 to 50 wt. % of monomeric units of the structural formula CH₂═C(R⁵)N(R⁶)C(O)R⁷ wherein R⁵, R⁶ and R⁷ are independently methyl, ethyl and hydrogen and optionally R⁶ and R⁷ form a cyclic amide.

Embodiment 25. The method of embodiment 24, wherein the relative permeability modifier further comprises from about 0.5 to 40 wt. % of monomeric units of the structural formula CH₂═C(R³)(R⁴) where R³ is hydrogen or and R⁴ is a (—PO₃²⁻) group.

Embodiment 26. The method of embodiment 24, wherein the monomeric units of (c) are selected from the group consisting of are N-vinyl acetamide, N-vinyl-N-methyl acetamide, N,N-dimethyl acetamide, N-vinyl 2-pyrrolidone, N-vinyl formamide and N-ethenyl-N-alkyl acetamide and mixtures thereof.

Embodiment 27. The method of embodiment 24, wherein the monomeric units of (a) are selected from the group consisting of acrylamide, methacrylamide, N-methylmethacrylamide, N-alkyl (C₁-C₄) methacrylamide, N,N-dialkyl (C₁-C₄) methacrylamide, N-alkyl (C₂-C₄) acrylamide, N,N-dialkyl (C₁-C₄) acrylamide and mixtures thereof.

Embodiment 28. The method of embodiment 24, wherein the monomeric units of (b) are selected from the group consisting of 2-acrylamido-alkyl sulfonic acid, vinyl sulfonic acid, vinyl benzene sulfonic acids, allyl sulfonic acid, methallyl sulfonic acid, 3-methacrylamideo-2-hydroxypropyl sulfonic acid, vinyl phosphonic acid and salts and combinations thereof.

Embodiment 29. A method of improving the performance of a relative permeability (RPM) macromolecule during production of hydrocarbons from a well by introducing the relative permeability (RPM) macromolecule into a well with one or more nanofillers, wherein:
the relative permeability modifier (RPM) macromolecule is either:
   (1) a copolymer comprising a hydrophilic monomeric unit and a first anchoring monomeric unit, wherein said first anchoring unit is based on at least one of N-vinylformamide, N,N-diallylacetamide or a mixture thereof; or
   (2) a crosslinked copolymer of:
      (i) 1 to 90 wt. % of monomeric units of the structural formula CH₂ ═C(R¹)—C(O)N(R²)₂ (I) where R¹ and R² independently represent a hydrogen, methyl, ethyl, propyl or butyl moiety;
      (ii) 1 to 75 wt. % of monomeric units of the structural formula CH₂═C(R³)(R⁴) (II) where R³ is hydrogen or methyl and R⁴ is a sulfo, sulfophenyl, sulfoalkyl, sulfoalkyl amido group or a phosphonic acid group or a sodium, potassium, ammonium, calcium, magnesium, partial salts or mixed salts thereof; and
      (iii) 1 to 50 wt. % of monomeric units of the structural formula CH₂═C(R⁵)N(R⁶)C(O)R⁷ wherein R⁵, R⁶ and R⁷ are independently methyl, ethyl and hydrogen and optionally R⁶ and R⁷ form a cyclic amide; and
      (iv) optionally, from about 0.5 to 40 wt. % of monomeric units of the structural formula CH₂═C(R³)(R⁴) where R³ is hydrogen or and R⁴ is a (—PO₃²⁻) group; and
      the nanofillers are selected from the group consisting of metal or metalloid oxides or hydroxides, metal or metalloid carbides, metal or metalloid nitrides, alkali metals, alkaline earth metals, a transition metal, a lanthanide, actinide, post-transition metals, alumina and boehmite, fullerenes, graphenes, nanographites, nanotubes, nanodots, nanodiamonds, nanoclays, polysilsesquioxanes, carbon nanotubes, inorganic nanotubes, metallated nanotubes, nano-layered silicates or nanoclays or exfoliated nanoclays or a combination thereof.

Embodiment 30. A method for reducing or eliminating the production of water in an oil or gas well by introducing into the well an aqueous fluid comprising:
a relative permeability modifier (RPM) macromolecule capable of impeding the production of water and being either:
(1) a copolymer comprising a hydrophilic monomeric unit and a first anchoring monomeric unit, wherein said first anchoring unit is based on at least one of N-vinylformamide, N,N-diallylacetamide or a mixture thereof; or
(2) a crosslinked copolymer of:
   (i) to 90 wt. % of monomeric units of the structural formula CH₂ ═C(R¹)—C(O)N(R²)₂ (I) where R¹ and R² independently represent a hydrogen, methyl, ethyl, propyl or butyl moiety;
   (ii) 1 to 75 wt. % of monomeric units of the structural formula CH₂═C(R³)(R⁴) (II) where R³ is hydrogen or methyl and R⁴ is a sulfo, sulfophenyl, sulfoalkyl, sulfoalkyl amido group or a phosphonic acid group or a sodium, potassium, ammonium, calcium, magnesium, partial salts or mixed salts thereof; and
      (iii) 1 to 50 wt. % of monomeric units of the structural formula CH₂═C(R⁵)N(R⁶)C(O)R⁷ wherein R⁵, R⁶ and R⁷ are independently methyl, ethyl and hydrogen and optionally R⁶ and R⁷ form a cyclic amide; and
      (iv) optionally, from about 0.5 to 40 wt. % of monomeric units of the structural formula CH₂═C(R³)(R⁴) where R³ is hydrogen or and R⁴ is a (—PO₃²⁻) group; and
   (v) optionally, from about 0.5 to 40 wt. % of monomeric units of the structural formula CH₂═C(R³)(R⁴) where R³ is hydrogen or and R⁴ is a (—PO₃²⁻) group; and
   the nanoparticles selected from the group consisting of metal or metalloid oxides or hydroxides, metal or metalloid carbides, metal or metalloid nitrides, alkali metals, alkaline earth metals, a transition metal, a lanthanide, actinide, post-transition metals, alumina and boehmite, fullerenes, graphenes, nanographites, nanotubes, nanodots, nanodiamonds, nanoclays, polysilsesquioxanes, carbon nanotubes, inorganic nanotubes, metallated nanotubes, nano-layered silicates or nanoclays or exfoliated nanoclays or a combination thereof.

What is claimed is:

1. A method for reducing or eliminating the production of water in an oil or gas well by introducing into the well an aqueous fluid comprising:
(a) a relative permeability modifier (RPM) macromolecule capable of impeding the production of water; and
(b) nanoparticles.

2. The method of claim 1, wherein the nanoparticles have a number average particle from about 5 to about 2,000 nm in diameter.

3. The method of claim 1, wherein the nanoparticles are selected from the group consisting of metal or metalloid oxides or hydroxides, metal or metalloid carbides, metal or metalloid nitrides, alkali metals, alkaline earth metals, a transition metal, a lanthanide, actinide, post-transition metals, alumina and boehmite.

4. The method of claim 3, wherein the nanoparticles are selected from the group consisting of silica, alumina, titania, silicic acid, aluminum oxides, aluminum hydroxides, magnesium oxide, zirconium oxides, zirconium hydroxides, zirconium hydroxyoxides, tungsten oxide, iron oxide, antimony oxide, vanadium oxide, tungsten carbide, silicon carbide, boron carbide, titanium nitride, boron nitride, silicon nitride, magnesium, aluminum, iron, tin, titanium, platinum, palladium, cobalt, nickel, vanadium, chromium, manganese, zirconium, ruthenium, hafnium, tantalum, tungsten, rhenium, osmium, barium titanate, strontium titanate or a combination thereof.

5. The method of claim 1, wherein the nanoparticles are selected from the group consisting of fullerenes, graphenes, nanographites, nanotubes, nanodots, nanodiamonds, nanoclays, polysilsesquioxanes, nano-layered silicates, nanoclays and combinations thereof.

6. The method of claim 5, wherein the nanoparticles are nanographene and graphene fibers having an average largest dimension of greater than 1 μm, a second dimension of less than 1 μm, and an aspect ratio of greater than 10, where the graphene particles form an interbonded chain.

7. The method of claim 5, wherein the nanoparticles are nanographene and graphene fibers are two-dimensional particles having more than one layer of fused hexagonal rings.

8. The method of claim 7, wherein the nanoparticles are graphene nanoparticles prepared by exfoliation of a graphite source.

9. The method of claim 5, wherein the nanoparticles are carbon nanotubes, inorganic nanotubes, metallated nanotubes or a combination thereof.

10. The method of claim 5, wherein the nanoparticles are aluminosilicate clays, hallyosite, bentonite, smectites, saponite, beidellite, nontrite, hectorite, allophane, illite, titanium sulfate, zirconium sulfate, exfoliated nanoclays and mixtures thereof.

11. The method of claim 1, wherein the nanoparticles are derivatized with a functional group selected from the group consisting of carboxy, epoxy, ether, ketone, amine, hydroxy, alkoxy, alkyl, aryl, aralkyl, alkaryl, lactone, organosilicon materials, fluorinated organic acids or a reactive derivative; linear or branched alkyl organic acids or a reactive derivative, substituted alkyl organic acids or a reactive derivative, aryl or substituted aryl organic acids or a reactive derivative and mixtures thereof.

12. The method of claim 1, wherein the nanoparticles are derivatized with one or more functional groups that are hydrophilic, hydrophobic, oxophilic, lipophilic, or oleophilic.

13. The method of claim 12, wherein the functional groups include (i) organosilicon materials, (ii) fluorinated organic acids or a reactive derivative; (iii) linear or branched alkyl organic acids or a reactive derivative, (iv) substituted alkyl organic acids or a reactive derivative, (v) aryl or substituted aryl organic acids or a reactive derivative as well as (vi) mixtures thereof.

14. The method of claim 12, wherein the nanoparticles are derivatized with a moiety selected from the group consisting of organophosphoric acids, organophosphonics acid and organophosphinic acids or a derivative thereof.

15. The method of claim 1, wherein the relative permeability modifier (RPM) macromolecule is a copolymer comprising a hydrophilic monomeric unit and a first anchoring monomeric unit, wherein said first anchoring unit is based on at least one of N-vinylformamide, N,N-diallylacetamide or a mixture thereof.

16. The method of claim 15, wherein the relative permeability modifier (RPM) macromolecule has a second anchoring monomeric unit based on at least one of dimethyldiallyl ammonium chloride, ammonium or alkali metal salts of acrylic acid or a mixture thereof.

17. The method of claim 1, wherein the relative permeability modifier (RPM) macromolecule is a crosslinked polymer based on N-substituted α, β-unsaturated carboxylic amide, a sulfonated or phosphonated vinyl monomer and optionally a copolymerizable crosslinking agent.

18. A method for reducing or eliminating the production of water in an oil or gas well by introducing into the well an aqueous fluid comprising:
a relative permeability modifier (RPM) macromolecule capable of impeding the production of water and being either:
(1) a copolymer comprising a hydrophilic monomeric unit and a first anchoring monomeric unit, wherein said first anchoring unit is based on at least one of N-vinylformamide, N,N-diallylacetamide or a mixture thereof; or
(2) a crosslinked copolymer of:
(i) 1 to 90 wt. % of monomeric units of the structural formula CH₂ ═C(R¹)—C(O)N(R²)₂ (I) where R¹ and R² independently represent a hydrogen, methyl, ethyl, propyl or butyl moiety;
(ii) 1 to 75 wt. % of monomeric units of the structural formula CH₂═C(R³)(R⁴) (II) where R³ is hydrogen or methyl and R⁴ is a sulfo, sulfophenyl, sulfoalkyl, sulfoalkyl amido group or a phosphonic acid group or a sodium, potassium, ammonium, calcium, magnesium, partial salts or mixed salts thereof; and
(iii) 1 to 50 wt. % of monomeric units of the structural formula CH₂═C(R⁵)N(R⁶)C(O)R⁷ wherein R⁵, R⁶ and R⁷ are independently methyl, ethyl and hydrogen and optionally R⁶ and R⁷ form a cyclic amide; and
(iv) optionally, from about 0.5 to 40 wt. % of monomeric units of the structural formula CH₂═C(R³)(R⁴) where R³ is hydrogen or and R⁴ is a (—PO₃²⁻) group; and
the nanoparticles selected from the group consisting of metal or metalloid oxides or hydroxides, metal or metalloid carbides, metal or metalloid nitrides, alkali metals, alkaline earth metals, a transition metal, a lanthanide, actinide, post-transition metals, alumina and boehmite, fullerenes, graphenes, nanographites, nanotubes, nanodots, nanodiamonds, nanoclays, polysilsesquioxanes, carbon nanotubes, inorganic nanotubes, metallated nanotubes, nano-layered silicates or nanoclays or exfoliated nanoclays or a combination thereof.

19. The method of claim 18, wherein the monomeric units of (i) are selected from the group consisting of acrylamide, methacrylamide, N-methylmethacrylamide, N-alkyl (C₁-C₄) methacrylamide, N,N-dialkyl (C₁-C₄) methacrylamide, N-alkyl (C₂-C₄) acrylamide, N,N-dialkyl (C₁-C₄) acrylamide and mixtures thereof; the monomeric units of (ii) are selected from the group consisting of 2-acrylamido-alkyl sulfonic acid, vinyl sulfonic acid, vinyl benzene sulfonic acids, allyl sulfonic acid, methallyl sulfonic acid, 3-methacrylamideo-2-hydroxypropyl sulfonic acid, vinyl phosphonic acid and salts and combinations thereof; and the monomeric units of (iii) are selected from the group consisting of are N-vinyl acetamide, N-vinyl-N-methyl acetamide, N,N-dimethyl acetamide, N-vinyl 2-pyrrolidone, N-vinyl formamide and N-ethenyl-N-alkyl acetamide and mixtures thereof.

20. A method of improving the performance of a relative permeability (RPM) macromolecule during production of hydrocarbons from a well by introducing the relative permeability (RPM) macromolecule into a well with one or more nanofillers, wherein:
the relative permeability modifier (RPM) macromolecule is either:
(1) a copolymer comprising a hydrophilic monomeric unit and a first anchoring monomeric unit, wherein said first anchoring unit is based on at least one of N-vinylformamide, N,N-diallylacetamide or a mixture thereof; or
(2) a crosslinked copolymer of:
(i) to 90 wt. % of monomeric units of the structural formula CH₂ ═C(R¹)—C(O)N(R²)₂ (I) where R¹ and R² independently represent a hydrogen, methyl, ethyl, propyl or butyl moiety;
(ii) 1 to 75 wt. % of monomeric units of the structural formula CH₂═C(R³)(R⁴) (II) where R³ is hydrogen or methyl and R⁴ is a sulfo, sulfophenyl, sulfoalkyl, sulfoalkyl amido group or a phosphonic acid group or a sodium, potassium, ammonium, calcium, magnesium, partial salts or mixed salts thereof; and
(iii) 1 to 50 wt. % of monomeric units of the structural formula CH₂═C(R⁵)N(R⁶)C(O)R⁷ wherein R⁵, R⁶ and R⁷ are independently methyl, ethyl and hydrogen and optionally R⁶ and R⁷ form a cyclic amide; and
(iv) optionally, from about 0.5 to 40 wt. % of monomeric units of the structural formula CH₂═C(R³)(R⁴) where R³ is hydrogen or and R⁴ is a (—PO₃²⁻) group; and
the nanofillers are selected from the group consisting of metal or metalloid oxides or hydroxides, metal or metalloid carbides, metal or metalloid nitrides, alkali metals, alkaline earth metals, a transition metal, a lanthanide, actinide, post-transition metals, alumina and boehmite, fullerenes, graphenes, nanographites, nanotubes, nanodots, nanodiamonds, nanoclays, polysilsesquioxanes, carbon nanotubes, inorganic nanotubes, metallated nanotubes, nano-layered silicates or nanoclays or exfoliated nanoclays or a combination thereof.
